(19) United States
(12) Patent Application Publication
(10) Pub. No.: US 2005/0235077 A1
(43) Pub. Date: Oct. 20, 2005

(54) Control system, control program product, control method, and control apparatus

(76) Inventor: Tsukasa Kubota, Kagoshima-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/094,940

(22) Filed: Mar. 30, 2005

(30) Foreign Application Priority Data
Mar. 31, 2004 (JP) 2004-102858

(51) Int. Cl. G06F 13/10

(52) U.S. Cl. 710/62

(57) ABSTRACT

A control system comprising: a detection unit for detecting services provided by devices connected to a network; a data input unit for inputting data from a first device detected by the detection unit and providing the service of inputting data; a conversion unit for converting a data format of the data input by the data input unit into a data format processable by a second device detected by the detection unit and providing the service of outputting data; and a service request unit for requesting the second device for a service for the data converted by the conversion unit.

### CROSS-REFERENCE TO RELATED APPLICATIONS

The disclosure of Japanese Patent Application No. JP2004-102858 filed on Mar. 31, 2004 including the specification, drawings and abstract is incorporated herein by reference in its entirety.

### BACKGROUND OF THE INVENTION

1. Field of the Invention

The present invention relates to a control system, a control program, a control method, and a control apparatus and particularly to an apparatus for integrally controlling various devices connected in a network.

2. Description of the Related Art

An end-user is generally required to configure complicated settings for setting up peripheral devices in order to put a computer into operation; therefore, it is necessary for the end-user to have basic knowledge about computers. As one of means for solving such problem, UPnP (Universal Plug and Play) is attracting attention. When a network is constituted of a multiple of UPnP devices, it is possible to use a television connected to the network, for example, for various purposes such as the purpose of displaying image data stored in a file sever in addition to the purpose of displaying TV broadcasting. Also, in the network, it is possible to control all devices by a control point constituted of a desktop PC (Personal Computer), a remote controller of TV, or the like, and, by executing a program for linking plural devices by the use of the control point, it is possible to realize a function which cannot be realized by a single device.

In the case of linking plural devices, data received from one device must be processed by another device. However, since the devices can be provided by different manufacturers, a data format of data transmitted from one device is not always in a data format which is processable by another device. Therefore, the devices to be linked must treat data identical in data format, which is problematic. In the case of the UPnP, for instance, data conversion between devices that fall under an identical category is defined, while data conversion between devices that are different in category is not defined. In the UPnP, for example, a printer and an image scanner fall under the same category, and a file server and a projector fall under the same category which is different from that of the printer and the image scanner. In this case, when printing out data stored in the file server by the printer, data which cannot be processed by the printer cannot be printed out by the printer since the data conversion between the file server and the printer is not defined.

### SUMMARY OF THE INVENTION

This invention has been created in view of the above-described problems, and an object thereof is to provide a control system, a control program product, a control method, and a control apparatus for linking devices which are connected to a network and different from each other in data format of data to treat.

(1) A control system for attaining the above object comprises a detection unit for detecting services provided by devices connected to a network; a data input unit for inputting data from a first device detected by the detection unit and providing the service of inputting data; a conversion unit for converting a data format of the data input by the data input unit into a data format which is processable by a second device detected by the detection unit and providing the service of outputting data; and a service request unit for requesting the second device for a service for the data converted by the conversion unit.

With this control system, since the data format of the data output from the first device is converted by the conversion unit into the data format processable by the second device, it is possible to link the first device to the second device even when the data format of the data treated by the first device is different from the data format of the data treated by the second device.

(2) The control system may further comprise a data format acquisition unit for acquiring from the second device data format information for specifying the data format which is processable by the second device; and a judgment unit for judging, based on the data format information acquired by the data format acquisition unit, whether or not the data format of the data input by the data input unit is the data format which is processable by the second device. The conversion unit may convert the data format of the data input by the data input unit into the data format which is processable by the second device when the judgment unit judges that the second device cannot process the data input by the data input unit.

With this control system, it is possible to acquire the information required for specifying the data format processable by the second device from the second device. Hence, in the case where there are plural second devices, it is unnecessary for the control system to store which data format is processable by each of the plural second devices. Therefore, in the case where another second device is added, it is unnecessary for a user to register information about a data format processable by the newly added second device, thereby reducing time required for operating the system.

(3) In the case where the data input by the data input unit are in an XML format and the second device does not interpret and process the XML format but processes data in text format, the conversion unit may convert the XML data into data which do not include tug information.

Since the XML data are text data, data with tug information will be printed out or displayed when it is impossible for the second device to interpret and process the XML format, and such print out or display is difficult for the user to understand. With this control system, since the XML data are converted into the data which do not include the tug information of the XML format when the second device cannot interpret the XML format, a processing result is easy for the user to understand.

(4) In the case where the data input by the data input unit are in a video format and the second device cannot interpret and process the video format but processes data in still image format, the conversion unit may divide the video data into plural series of still image data.

With the control system, it is possible to confirm contents of the video by the use of the second device which cannot process the video.

(5) A control program product for attaining the above object comprises enabling a computer to function as a detection unit for detecting services provided by devices connected to a network; a data input unit for inputting data from the first device detected by the detection unit and providing the service of inputting data; a conversion unit for converting a data format of the data input by the data input unit into a data format which is processable by the second device detected by the detection unit and providing the service of outputting data; and a service request unit for requesting the second device for a service for the data converted by the conversion unit.

With the control program product, it is possible to link the devices which are connected to the network and different from each other in data format of data to treat.

(6) A control method for attaining the above object comprises: a detection step of detecting services provided by devices connected to a network; a data input step of inputting data from the first device detected by the detection unit and providing the service of inputting data; a conversion step of converting a data format of the data input by the data input unit into a data format processable by the second device detected by the detection unit and providing the service of outputting data; and a service request step of requesting the second device for a service for the data converted by the conversion unit.

With the control method, it is possible to link the devices which are connected to the network and different from each other in data format of data to treat.

(7) A control apparatus for attaining the above object comprises a detection unit for detecting services provided by devices connected to a network; a data input unit for inputting data from the first device detected by the detection unit and providing the service of inputting data; a conversion request unit for requesting a third device for processing of converting a data format of the data input by the data input unit into a data format processable by the second device detected by the detection unit and providing the service of outputting data; and a service request unit for requesting the second device for a service for the data converted by the third device.

With the control method, it is possible to link the devices which are connected to the network and different from each other in data format of data to treat. Further, in the case where each of plural users link the devices by the use of a control apparatus owned by the user, it is unnecessary for each of the control apparatuses to include a data format conversion unit because the data format conversion unit is centralized in the third device. Hence, it is possible to suppress an increase in cost otherwise incurred by time required for management of the control apparatus and providing the data format conversion unit to each of the control apparatuses.

Each of the functions of the units provided in this invention is realized by a hardware resource whose function is specified by its constitution, a hardware resource whose function is specified by a program, or a combination thereof. Also, each of the functions of the units is not limited to that realized by a hardware resource which is physically independent from other hardware resources.

### BRIEF DESCRIPTION OF THE DRAWINGS

FIG. 1 is a schematic diagram showing processing by a control system according to a first embodiment of this invention.

FIG. 2 is a schematic diagram showing a network according to the first embodiment of this invention.

FIG. 3 is a block diagram showing the control system according to the first embodiment of this invention.

FIG. 4 is a flowchart of the control system according to the first embodiment of this invention.

FIG. 5 is a schematic diagram showing a table of the control system according to the first embodiment of this invention.

FIG. 6 is a schematic diagram showing a screen according to the first embodiment of this invention.

FIG. 7 is a diagram for illustrating the table of the control system according to the first embodiment of this invention.

FIG. 8 is a schematic diagram showing a transition of screens according to the first embodiment of this invention.

FIG. 9 is a schematic diagram of a screen of the control system according to the first embodiment of this invention.

FIG. 10 is a schematic diagram showing processing of the control system according to the first embodiment of this invention.

FIG. 11 is a schematic diagram showing a transition of screens according to a second embodiment of this invention.

FIG. 12 is a flowchart of a control system according to the second embodiment of this invention.

FIG. 13 is a schematic diagram showing a network according to a third embodiment of this invention.

FIG. 14 is a flowchart of a control apparatus according to the third embodiment of this invention.

### DETAILED DESCRIPTION OF THE INVENTION

Hereinafter, the best mode for carrying out this invention will be described in conjunction with embodiments.

### First Embodiment

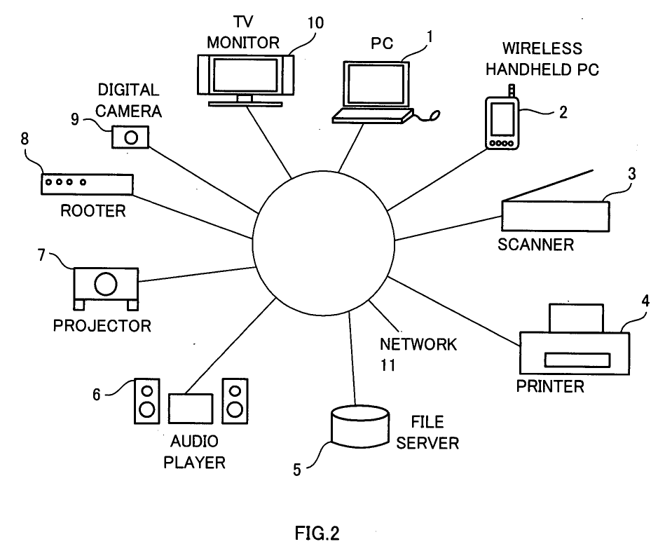

A control system according to the first embodiment of this invention is a UPnP control point such as a PC (Personal Computer) 1 shown in FIG. 2 or the like. Though the first embodiment will be described by using the PC 1 as an example of the control system, the control apparatus of this invention may be a wireless handheld PC 2, a mobile phone (not shown), or the like. A control program of the first embodiment is executed by the UPnP control point such as the PC 1. Examples of UPnP devices to be connected to a UPnP network 11 include a scanner 3, a printer 4, a file server 5, an audio player 6, a projector 7, a rooter 8, a digital camera 9, a TV (Television) monitor 10, and the like.

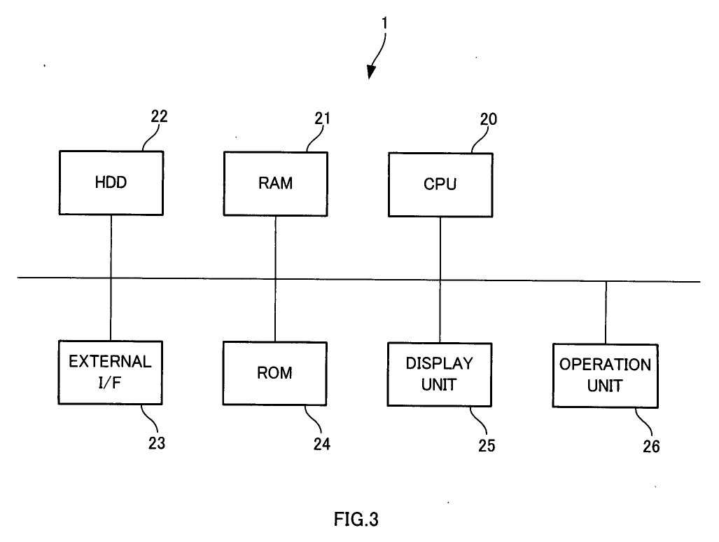

FIG. 3 is a block diagram showing a hardware structure of the PC 1 serving as the control system. The PC 1 is provided with a CPU 20, a RAM 21, a hard disk device (HDD) 22, an external interface 23, a ROM 24, a display unit 25, and an operation unit 26. The CPU 20 functions as a detection unit, a data input unit, a conversion unit, a service request unit, a data format acquisition unit, and a judgment unit by executing the control program.

The ROM 24 is a memory in which a program for initial operation of the CPU 20 is stored. The RAM 21 is a memory for temporarily storing the control program and data to which the control program accesses. The HDD 22 is an external storage for storing the control program, various types of data to which the control program accesses, and the like. In addition, the control program may be stored in a semiconductor memory such as a flash memory.

The external interface 23 is an interface for connecting the PC 1 to an external device, and specific examples thereof include a LAN card and the like. The display unit 25 has a CRT, an LCD, a display controller, and the like and displays GUI (Graphical User Interface) screens each constituted of screen components such as a control screen component and the like. The control screen component is a screen constituent which is operated by a pointing device such as a mouse and used for interactively accepting operations for calling up a predetermined program, changing a parameter, and the like, and examples thereof include a button, a drop down list box, and the like. The operation unit 26 has a keyboard and a pointing device (mouse, tablet, and the like).

Hereinafter, processing for controlling the UPnP devices by the use of the PC 1 will be described.

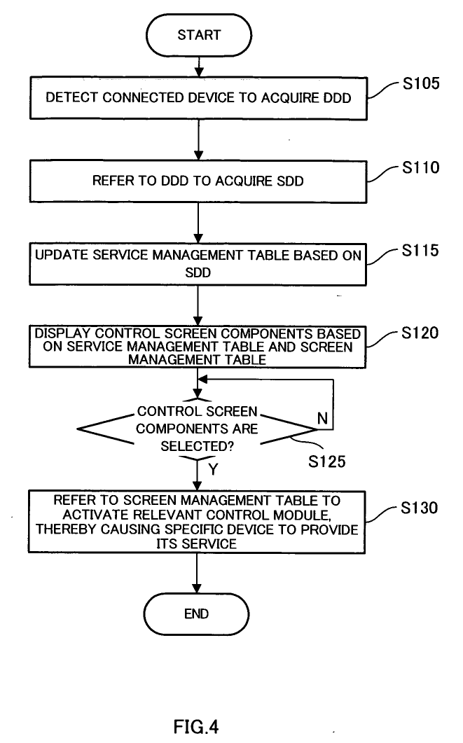

FIG. 4 is a flowchart illustrating a flow of the processing for controlling the UPnP devices by the use of the PC 1 which operates as the UPnP control point. The PC 1 executes the control program to perform the processing shown in FIG. 4.

When one UPnP device is connected to a network, the UPnP device informs other UPnP devices of its existence periodically by using an SSDP (Simple Service Discovery Protocol) on the network. The SSDP is a multicast discovery protocol obtained by extending an HTTP (Hypertext Transfer Protocol) header. A link to a DDD (Device Description Document) described in an XML (extensible Markup Language) format is included in a discovery packet. A URL for referring to an SDD (Service Description Document) defined by the UPnP is described in the DDD in addition to a device type, a manufacturer, a model, and so forth. In the step S105, the PC 1 detects the UPnP device from the SSDP to acquire the DDD of the detected device. Alternatively, the PC 1 can inquire connection states of the other UPnP devices by the use of the SSDP to proactively detect the UPnP device.

In the step S110, the PC 1 refers to the URL described in the DDD to acquire the SDD in which a service provided by the device is described in detail in the XML format. By the acquisition of the SDD, the PC 1 detects the service provided by the device connected to the UPnP network 11 and acquires information of an action and a state variable as control information for causing the device to provide the service and data format information. The data format information is information to be used for specifying a data format processable by a device. For example, in the case where a printer serving as the device can interpret data in text format and JPEG format and can convert the data into print data, the text format and the JPEG format are included as the data format information in an SDD in which a service provided by the printer, i.e. the service of printing out, is described.

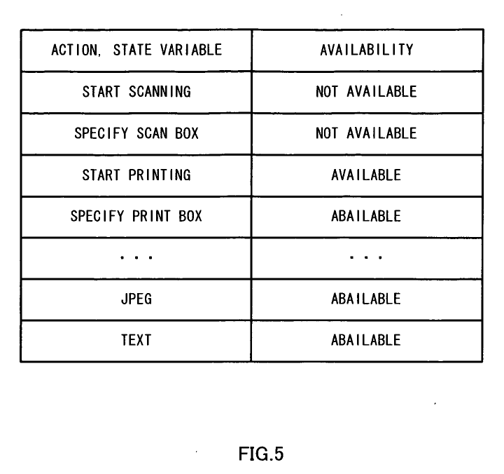

In the step S115, the PC 1 updates a service management table shown in FIG. 5 based on the SDD. The service management table is data to be used for managing provision states of the UPnP devices actually connected to the UPnP network 11 in terms of all services defined by a DCP (Device Control Protocol) In the service management table, availability of actions and state variables of the services defined by the DCP and minimum information (address of message) required for using the services, and data format information are described.

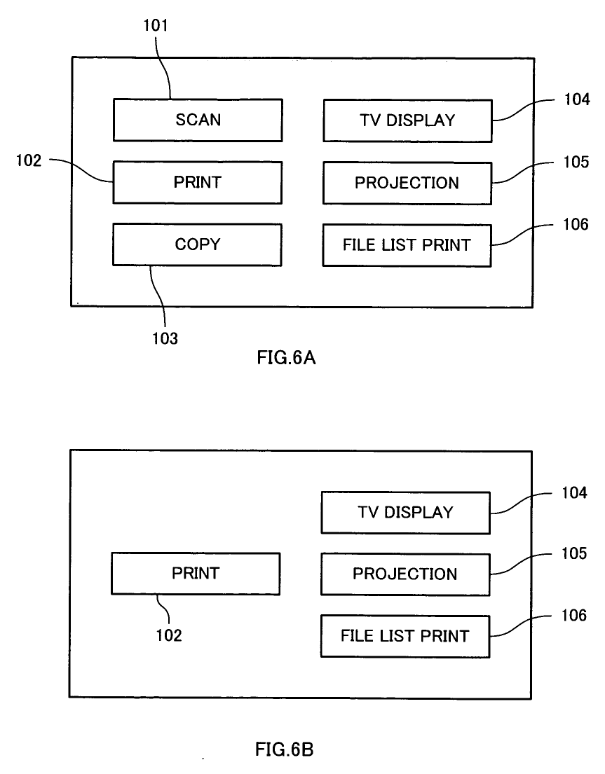

In the step S120, the PC 1 refers to the service management table and the screen management table to display a screen such as that shown in FIG. 6 on the display unit 25 in such a fashion that a user can select any of control screen components corresponding to the services provided by the devices connected to the UPnP network 11. Among buttons 101, 102, 103, 104, 105, and 106, only the selectable buttons may be displayed depending on connection states of the devices, or those which cannot be selected because the corresponding devices are not connected may be displayed in gray color and in such a fashion that the pointing device cannot select them. Shown in FIG. 6A is a control screen to be displayed on the display unit 25 when the UPnP network 11 is in a state shown in FIG. 2, while shown in FIG. 6B is a control screen to be displayed on the display unit 25 when the UPnP network 11 is in a state the same as that shown in FIG. 2 except for disconnection of the scanner 3.

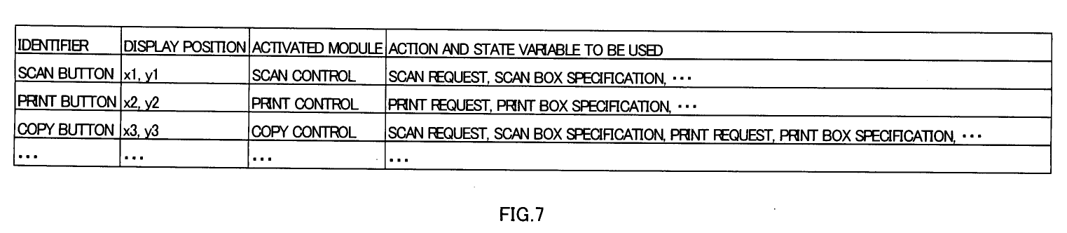

FIG. 7 is a schematic diagram showing the screen management table. The screen management table is a table for managing control screen components to be used for accepting a user's request and the like to use a service controllable by using the actions and the state variables defined by the DCP and is prestored in the HDD 22 as a part of the control program. Each of records in the screen management table is used for associating an identifier (label, pointer, or the like) for accessing to resource data of the relevant control screen component, a display position on the screen, information (label, program pointer, or the like) for calling up a module to be activated upon selection, and an action and a state variable to be used by a program activated upon selection of each of the control screen components with one another. The PC 1 specifies the control screen component for which all the actions and state variables to be used by the activated module are “AVAILABLE” in the service management table to display the specified control screen component as selectable on the screen of the display unit 25. In addition, the control screen components are associated with the services provided by the UPnP devices via the screen management table and the service management table.

In the step S125, upon selection of one of the control screen components by way of a click of the mouse, the PC 1 refers to the screen management table to call up a module associated with the selected control screen component. For example, when the scan button 101 shown in FIG. 6 is selected, a main module of the control program uses the label described in the screen management table to call up a scan control module for controlling a scan service of the scanner 3. The scan control module sends a massage containing an action and a state variable to the scanner 3 at a predetermined sequence to operate the UPnP scanner 3 under the control of the PC 1. The message containing the action and the state variable is sent to an address described in the SDD acquired in the step S110. Also, when the print button 102 is selected, for example, the main module of the control program uses the label described in the screen management table to call up a print control module for controlling the printer 4. The print control module sends a massage containing an action and a state variable to the printer 4 at a predetermined sequence to operate the printer 4 under the control of the PC 1. In addition, each of messages such as the print request may be sent once or may be sent in plural batches. For instance, it is possible to control one service by correlating messages with actions defined by the DCP on one-on-one basis and repeating transmission between the PC 1 and a device to be controlled.

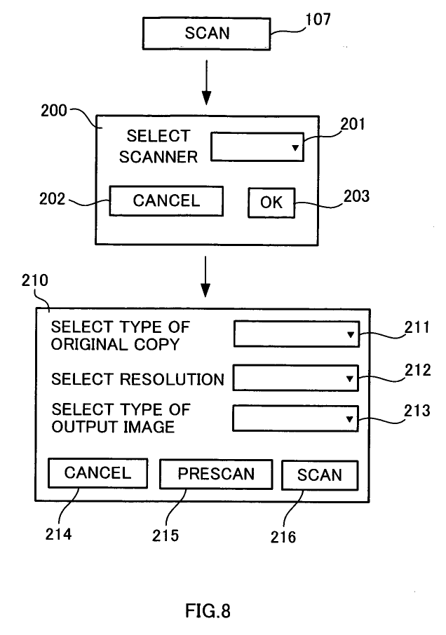

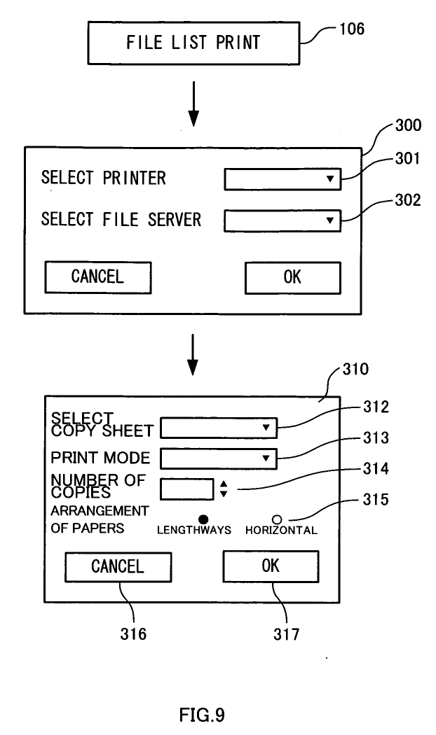

In the case where plural UPnP devices which provide an identical service are connected to the PC 1, the PC 1 may display a screen for selecting one of the UPnP devices on the display unit 25. Specifically, a screen 200 shown in FIG. 8 and a screen 300 shown in FIG. 9 are displayed, for example, and devices selected by operating drop down list boxes 201, 301, and 302 are specified as devices with which modules to be executed when the buttons 101 and 106 are selected communicate. More specifically, a URL which is described in an SDD of the specified device and used for calling an action belonging to a service is set as an address to which a message for calling the action is sent.

Alternatively, the PC 1 may hierarchically display a menu screen consisting of the control screen components. Specifically, the PC 1 may display a screen 210 shown in FIG. 8 and a screen 310 shown in FIG. 9 to interactively accept operations of the devices to be controlled. Each of control screen components 211, 212, 213, 312, and 313 displayed in the screens 210 and 310 is a drop down list box to be used for changing a state variable. A control screen component 314 is an up down control used for increasing and reducing a value. A control screen component 315 is a radio button used for changing a state variable. Each of control screen components 214, 215, 216, 316, and 317 displayed in the screens 210 and 310 is a button to be used for calling an action.

Hereinafter, processing of operating the printer 4 under the control of the PC 1 will be described.

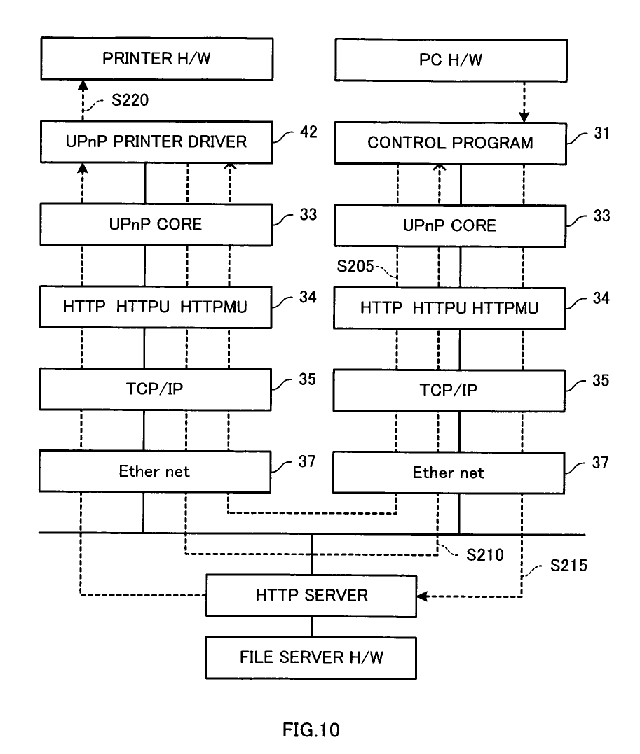

FIG. 10 is a schematic diagram for specifically illustrating the processing of operating the printer 4 under the control of the PC 1. When the print button 102 is selected by a click on the control screen shown in FIG. 6A, the main module of the control program 31 uses the label of the activated module described in the screen management table to call up a print control module for controlling the print service provided by the printer 4. The called up print control module sends a print request to a UPnP printer driver 42 of the printer 4 via a UPnP core 33, an HTTP 34, a TCP/IP 35, and an Ehternet 37 (S205). Various parameters such as a selection of sheet are specified in the print request. The UPnP printer driver 42 which has received the print request sends a URL of a print box as a posting address of data to be printed out to the control program 31 of the PC 1 via the UPnP core 33, the HTTP 34, the TCP/IP 35, and the Ehternet 37 (S210). The control program 31 inputs image data, for example, from the file server to send the input image data to the specified print box (S215). The UPnP printer driver 32 which has received the request of printing out the image data acquires the image data from the print box and converts the image data into print data to execute printing out by controlling a hardware 41 of the printer 4 (S220). As a result, the image data are output by the printer 4.

Hereinafter, functions each of which is realized by a combination of services which are provided by plural devices and different from one another will be described. Examples of such functions include a copying function wherein the printer 4 prints out an image scanned by the scanner 3, a print function wherein the printer prints out image data stored in the file server 5, a file list print function wherein the printer prints out a list of files stored in the file server 5, a slide show function wherein the TV monitor 10, the projector 7, a digital picture flame, or the like displays images sequentially supplied at predetermined constant intervals from the file server 5 or the digital camera 9, a music replay function wherein the audio player 6 replays a series of music data supplied at a random order from the file server 5, and the like. In order to realize the functions, it is necessary for the device for outputting data to process a data format of data to be input thereto. However, since the UPnP devices are not defined in terms of data format conversion between devices under different categories, a data format of data input from one device is not always a data format processable by another device. Therefore, in the first embodiment, the PC 1 converts a data format of data input from a data input device (first device) into a data format processable by a data output device (second device) to link the first device to the second device. As used herein, the first device corresponds to the scanner 3, the file server 5, and the digital camera 9 in the above-described combinations. For example, the scanner 3 is a device for providing a service of supplying data to other devices by scanning an original copy to generate image data of the original copy and sending the generated image data to the other devices. The file server is a device for providing a service of supplying data to other devices by sending data stored therein to the other devices. The second device corresponds to the printer, the TV monitor 10, the projector 7, the digital picture flame, and the audio player 6.

Hereinafter, a flow of processing of linking the first device to the second device when a data format of data treated by the first device is different from a data format of data treated by the second device will be described.

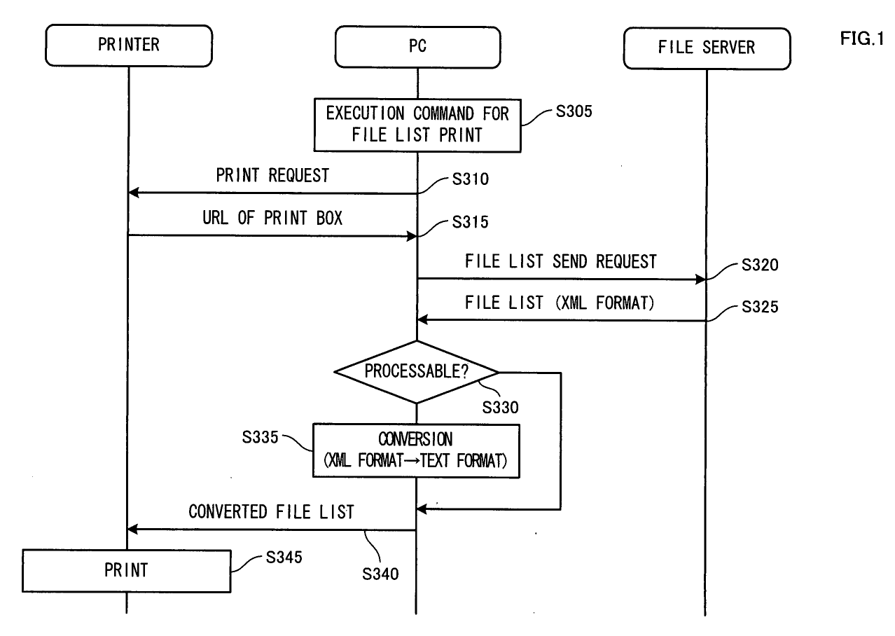

FIG. 1 is a sequence chart showing the flow of processing of linking the first device to the second device. An example wherein the file list print button 106 is selected by clicking will be described.

In the step S305, the PC 1 receives a command for executing file list print. Specifically, a user clicks the file list print button 106 on the control screen shown in FIG. 6A so that the PC 1 receives the execution command. Upon receipt of the execution command, the screen 300 shown in FIG. 9 is displayed so that the PC 1 receives selections relating to the printer and the file server, and then the screen 310 is displayed so that the PC 1 receives selections of parameters such as the number of copies.

In the step S310, the main module of the control program 31 uses the label of the activated module described in the screen management table to call up a print control module for controlling the print service provided by the printer 4. The called up print control module sends a print request to the UPnP printer driver 42 of the printer 4 via the UPnP core 33, the HTTP 34, the TCP/IP 35, and the Ehternet 37. Various parameters such as the number of copies are specified in the print request.

In the step S315, the UPnP printer driver 42 which has received the print request sends a URL of a print box as a posting address of data to be printed out to the control program 31 of the PC 1 via the UPnP core 33, the HTTP 34, the TCP/IP 35, and the Ehternet 37.

In the step 320, upon receipt of the URL of the print box, the main module of the control program 31 uses the label of the activated module described in the screen management table to call up a data store control module for controlling a data store service of the file server. The called up data store control module sends a file list send request to a UPnP file server control program 31 via the UPnP core 33, the HTTP 34, the TCP/IP 35, and the Ehternet 37.

In the step 325, upon receipt of the file list send request, the UPnP file server control program 31 sends the file list as XML data to the control program 31 of the PC 1 via the UPnP core 33, the HTTP 34, the TCP/IP 35, and the Ehternet 37.

In the step 330, the control program 31 judges whether or not a data format of the data acquired from the first device, i.e. a data format of the file list received from the file server, is processable by the printer based on the service management table. In this specification, it is presumed that the printer interprets data in text format but does not interpret data in XML format.

In the step S335, the PC 1 interprets the XML data to convert the data into a plain text which does not include tug information.

In the step S340, the main module of the control program 31 sends the converted data to the print box. Thus, processing of requesting the printer which is the second device for the service for the converted data is completed.

In the step S345, upon receipt of the converted file list, the UPnP printer driver 32 converts the file list in text format into print data and controls the hardware 41 of the printer 4 based on the print data. As a result, the file list is printed out by the printer 4. Since the printed content is the data which do not include the tug information of the XML format, the content is easy for the user to understand.

With the PC 1 according to the first embodiment of this invention described above, it is possible to output the printing result which is easy for users to understand since the PC 1 interprets the data in XML format input from the file server to convert the data into the data in text format from which the tug information is eliminated. Therefore, with the PC 1, it is possible to link the file server to the printer when a data format of data treated by the file server is different from a data format of data treated by the printer.

Also, the PC 1 acquires the information for specifying the data format processable by the printer 4 from the printer 4; therefore, even in the case where there are plural printers 4, it is unnecessary for the PC 1 to store all data formats processable by the printers 4. Accordingly, when another printer is added, a user does not have to perform operation for storing information about the data format processable by the newly added printer in the PC 1, thereby reducing time required for operating the system.

Further, since the PC 1 displays the control screen components whose resource data have been stored in accordance with the DCP in response to a connection state of the device to autonomously acquire information (control information) for controlling the device from the device itself, it is unnecessary for the user to input the resource data and the control information of the control screen components every time the user connects the device to the network 1. Therefore, operations of the various devices used as being connected to the network are facilitated.

In addition, though the example of applying this invention to the UPnP network is described in the foregoing embodiment, it is possible to apply this invention to any network so far as the network is constituted by using a protocol for activating plural network devices actively under the control of a specific control system.

### Second Embodiment

The second embodiment is an example of printing out a video stored in a file server.

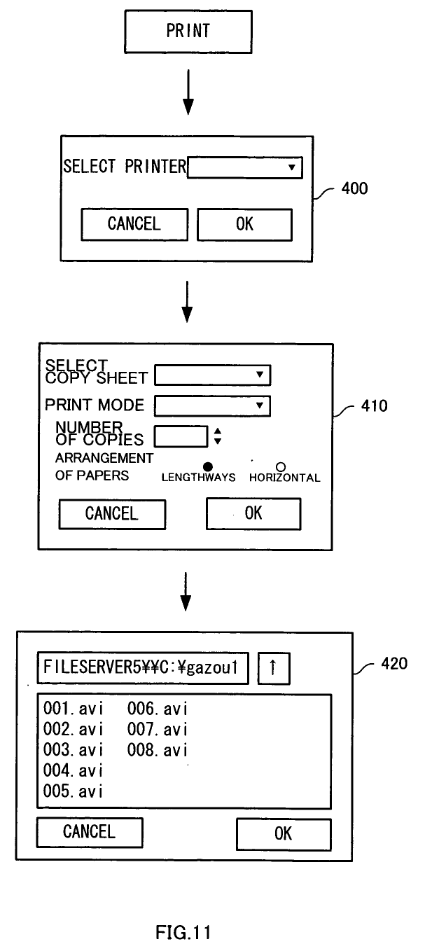

FIG. 11 is a diagram showing a transition of screens when PRINT is selected. When PRINT is selected, a screen 400 for selecting a printer, a screen 410 for setting various parameters such as a printing condition, and a screen 420 for selecting a file to be printed out are displayed as shown in FIG. 11. In addition, the screen 420 for selecting a file to be printed may be displayed to start with.

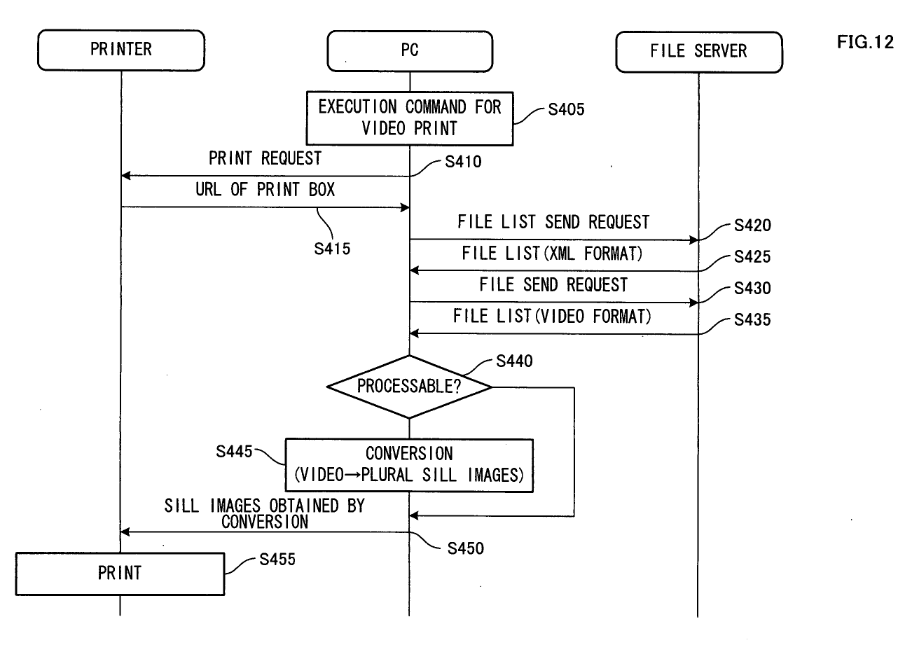

FIG. 12 is a sequence chart showing a flow of processing of printing a video by the printer.

In the step S405, the PC 1 receives a command for executing printing. Specifically, a user clicks the print button 102 on the control screen shown in FIG. 6A so that the PC 1 receives the execution command.

In the step S410, the main module of the control program 31 uses the label of the activated module described in the screen management table to call up a print control module for controlling the print service provided by the printer 4. The called up print control module sends a print request to the UPnP printer driver 42 of the printer 4 via the UPnP core 33, the HTTP 34, the TCP/IP 35, and the Ehternet 37. Various parameters such as the number of copies are specified in the print request.

In the step S415, the UPnP printer driver 42 which has received the print request sends a URL of a print box as a posting address of data to be printed out to the control program 31 of the PC 1 via the UPnP core 33, the HTTP 34, the TCP/IP 35, and the Ehternet 37.

In the step S420, upon receipt of the URL of the print box, the main module of the control program 31 uses the label of the activated module described in the screen management table to call up a data store control module for controlling a data store service of the file server. The called up data store control module sends a file list send request to the UPnP file server control program 31 of the file server via the UPnP core 33, the HTTP 34, the TCP/IP 35, and the Ehternet 37.

In the step 425, upon receipt of the file list send request, the UPnP file server control program 31 sends a file list to the control program 31 of the PC 1 via the UPnP core 33, the HTTP 34, the TCP/IP 35, and the Ehternet 37.

In the steps S430 and S435, the control program 31 extracts data in video format from the received data list to display the list in the screen 420. The user selects from the displayed video list a video that she/he wants to print out. When the user selects one of the videos, the control program 31 sends a request for sending the selected video data to the file server to receive the video data.

In the step S440, it is judged whether or not the printer can process the video data based on the service management table. In this specification, it is presumed that the printer interprets data in still image format but does not interpret the data in video format.

In the step S445, the PC separates plural still images constituting the video into still images independent from one another. For instance, plural still images in JPEG format corresponding to plural flames at predetermined intervals are extracted from a video in Motion JPEG format. Also, for example, plural flames whose data are stored independent from adjacent flames are extracted from a video in MPEG format as still images. Then, reduced images of the separated still images, i.e. thumbnail images, are generated.

In the step S450, the generated thumbnail images are sent to the print box.

In the step S455, the UPnP printer driver 32 acquires the plural thumbnail images and then converts the thumbnail images into print data for printing a list to control the hardware 41 of the printer 4 based on the print data.

With the PC according to the second embodiment of this invention described above, it is possible to confirm a content of a video by the use of the printer which cannot process any video.

### Third Embodiment

The third embodiment is an example of converting data by the use of a third device connected to a network, not by the UPnP control point.

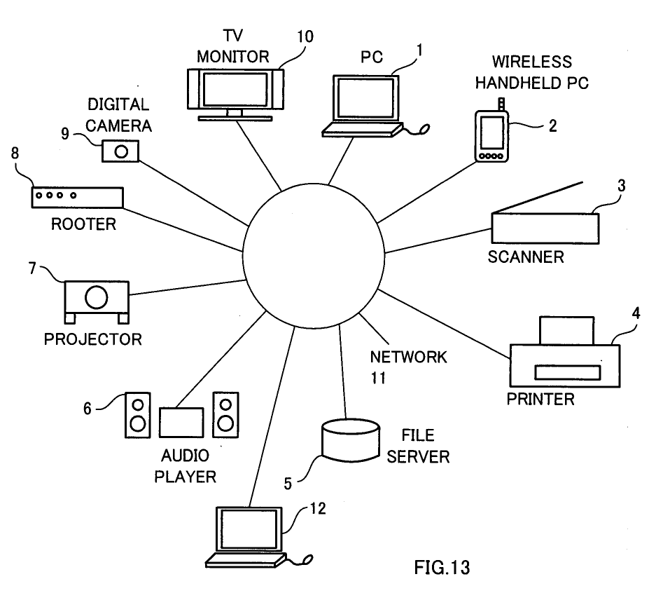

FIG. 13 is a schematic diagram showing one example of a UPnP device to be connected to a UPnP network 11 of the third embodiment. In the example shown in FIG. 13, a conversion server 12 is connected as the third device in addition to the example shown in FIG. 2. The conversion server 12 is connected in such a fashion as to communicate in accordance with the UPnP protocol, too. A control program executed by the PC 1 of the third embodiment enables the PC 1 to function as a control apparatus, so that the PC 1 requests the conversion server 12 for conversion of data when the data are input to the PC 1.

Hereinafter, a flow of processing of the third embodiment will be described. An example of converting data in XML format into data in text format from which tug information is eliminated will be described.

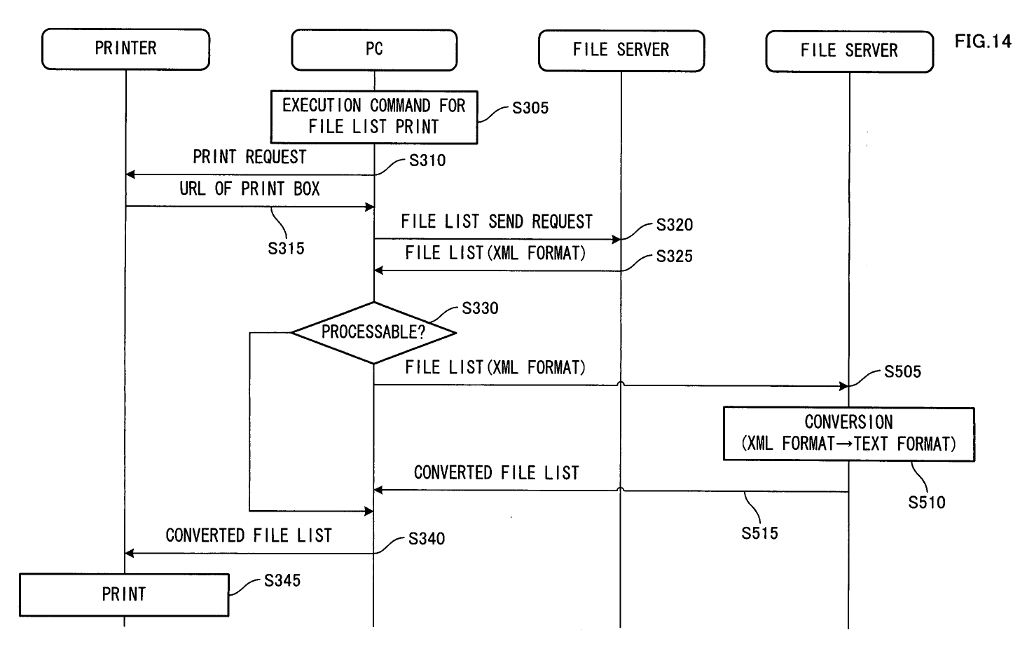

FIG. 14 is a sequence chart showing a flow of the processing of the third embodiment. In FIG. 14, processing substantially identical with those of FIG. 1 are denoted by the same reference numerals to omit the descriptions thereof.

In the step S505, a PC 1 serving as the control apparatus sends file list data in XML format to the conversion server 12.

In the step S510, the conversion server 12 converts the received file list data in XML format into data in text format from which tug information is eliminated to send the converted data to the PC1.

In the step S515, the PC sends the data received from the conversion server 12 to the print box.

With the PC 1 of the third embodiment described above, in the case where each of plural users links the devices by the use of her/his PC 1, the data format conversion unit does not have to be provided in each of the PCs since the data format conversion unit is centralized in the conversion server 12. Therefore, it is possible to suppress an increase in cost otherwise incurred by time required for management and providing the conversion unit to each of the PCs.

1. A control system comprising:
a detection unit for detecting services provided by devices connected to a network;
a data input unit for inputting data from a first device detected by the detection unit and providing the service of inputting data;
a conversion unit for converting a data format of the data input by the data input unit into a data format processable by a second device detected by the detection unit and providing the service of outputting data; and
a service request unit for requesting the second device for a service for the data converted by the conversion unit.

2. The control system according to claim 1, further comprising:
a data format acquisition unit for acquiring from the second device data format information for specifying the data format which is processable by the second device; and
a judgment unit for judging, based on the data format information acquired by the data format acquisition unit, whether or not the data format of the data input by the data input unit is the data format which is processable by the second device, wherein
the conversion unit converts the data format of the data input by the data input unit into the data format which is processable by the second device when the judgment unit judges that the second device cannot process the data input by the data input unit.

3. The control system according to claim 1 or 2, wherein, in the case where the data input by the data input unit are in an XML format and the second device does not interpret and process the XML format but processes data in text format, the conversion unit converts the XML data into data which do not include tug information.

4. The control system according to claim 1 or 2, wherein, in the case where the data input by the data input unit are in a video format and the second device does not interpret and process the video format but processes data in still image format, the conversion unit divides the video data into plural series of still image data.

5. A control program product comprising enabling a computer to function as:
a detection unit for detecting services provided by devices connected to a network;
a data input unit for inputting data from a first device detected by the detection unit and providing the service of inputting data;
a conversion unit for converting a data format of the data input by the data input unit into a data format processable by a second device detected by the detection unit and providing the service of outputting data; and
a service request unit for requesting the second device for a service for the data converted by the conversion unit.

6. A control method comprising:
a detection step of detecting services provided by devices connected to a network;
a data input step of inputting data from a first device detected by the detection unit and providing the service of inputting data;
a conversion step of converting a data format of the data input by the data input unit into a data format processable by a second device detected by the detection unit and providing the service of outputting data; and
a service request step of requesting the second device for a service for the data converted by the conversion unit.

7. A control apparatus comprising:
a detection unit for detecting services provided by devices connected to a network;
a data input unit for inputting data from a first device detected by the detection unit and providing the service of inputting data;
a conversion request unit for requesting a third device for processing of converting a data format of the data input by the data input unit into a data format processable by a second device detected by the detection unit and providing the service of outputting data; and
a service request unit for requesting the second device for a service for the data converted by the third device.
